(19) United States
(12) Patent Application Publication
(10) Pub. No.: US 2026/0268511 A1
(43) Pub. Date: Sep. 10, 2026

(54) METHOD AND APPARATUS FOR RECOGNIZING A DIMENSION OF AN OBJECT

(71) Applicant: SICK AG, Waldkirch (DE)

(72) Inventors: Kai HERZ, Breisach am Rhein (DE); Franziska SCHIRRMACHER, Freiburg im Breisgau (DE); Stefan WERNER, Paderborn (DE)

(21) Appl. No.: 19/558,215

(22) Filed: Mar. 5, 2026

(30) Foreign Application Priority Data
Mar. 6, 2025 (EP) 25162032.4

(51) Int. Cl. G06T 7/62; G06T 7/00; G06T 7/11; G06T 7/50; G06V 10/77; G06V 10/82

(52) U.S. Cl. CPC G06T 7/62; G06T 7/0004; G06T 7/11; G06T 7/50; G06V 10/7715; G06V 10/82; G06T 2207/10024; G06T 2207/10028; G06T 2207/20081; G06T 2207/20084; G06T 2207/30108; G06V 2201/06

(57) ABSTRACT

A computer-implemented method for recognizing a dimension of a first object that is arranged in an industrial plant comprises generating a 2D image and a depth image by means of a camera device of the industrial plant, wherein the 2D image and the depth image include the first object and a second object; applying an instance segmentation model to the 2D image to generate a first segmentation mask for the first object and a second segmentation mask for the second object, wherein the instance segmentation model comprises a convolutional neural network that comprises a first module and a second module that are linked to one another; obtaining first depth information of the first object from the depth image using the first segmentation mask; and obtaining the dimension of the first object based on the first depth information.

The invention relates to a computer-implemented method and to an apparatus for recognizing at least one dimension of at least one object that is arranged in an industrial plant.

Automatic image recognition processes, in particular those in which an artificial neural network such as a convolutional neural network (CNN) is used, are used in various technical areas. They are used, for example, to determine the relative position of an object within an industrial plant, to determine the dimensions of an object or to recognize defects on an object, i.e. for quality assurance. Based on the information obtained through the automatic image recognition, a part of an industrial plant is then usually controlled. The industrial plant is, for example, an industrial plant in the logistics sector (e.g. a goods distribution center) or an industrial plant in an industrial production environment.

For the automatic measurement or dimensioning of individual objects, for example, images of the object are first generated using one or more optical sensors of the industrial plant. The images are then usually fed via a data connection to a separate data processing device on which image recognition software is executed. This has the disadvantage that comparatively large amounts of data have to be transmitted between the sensors and the data processing device. Furthermore, existing solutions are still prone to errors in some situations, in particular if a plurality of objects are to be dimensioned automatically at the same time.

It is therefore an object of the invention to improve the automatic recognition and/or dimensioning of objects.

The aforementioned object is satisfied according to the invention by the features of the independent claims.

A computer-implemented method according to the invention for recognizing at least one dimension of at least a first object that is arranged in an industrial plant comprises generating a 2D image and a depth image by means of at least one camera device of the industrial plant.

The industrial plant is, for example, an industrial plant in the logistics sector.

However, it can also be part of an industrial production environment for manufacturing products.

The dimension is, for example, a height, length and/or width of the object, i.e. a length measurement that characterizes the object. From this, further information that characterizes the object, such as a volume of the object, can be calculated. In addition or as an alternative to the dimension, one or more corner points of the object, preferably in the camera coordinate system, and/or the angle of rotation of the object can also be determined (and output).

The camera device comprises, for example, one or more, in particular two, preferably high-resolution digital cameras that are configured to generate the 2D image and the depth image. Preferably, the camera device is an RGBD camera (red-green-blue depth camera) that is configured to generate an RGBD image (red-green-blue depth image) and to extract the 2D image and the depth image from the RGBD image. The camera device preferably works based on the stereo vision principle or as LiDAR. However, the camera device can also be configured to generate the 2D image and the depth image individually in each case, i.e. with separate sensors.

The camera device preferably comprises a memory and a processor, wherein the memory is configured to store computer-executable instructions that, when they are executed by the processor, cause the processor to perform at least a part of the method according to the invention. However, it can also be provided that at least a part of the method according to the invention is stored on an external memory and/or is executed by an external processor.

The camera device can be a component of an apparatus according to the invention for recognizing at least one dimension of at least a first object that is arranged in an industrial plant, which apparatus is described further below.

The 2D image can be a black-and-white image, a grayscale image and/or a color image, in particular an RGB image (red-green-blue image).

Each pixel in the depth image preferably includes a value that indicates the distance (depth information) of the object or a part or region of the object from the camera device, in particular an image sensor of the camera device.

The 2D image and the depth image include the first object and at least a second object. Depending on the application, the 2D image and the depth image can also include three or more objects.

The method further comprises applying an instance segmentation model to the 2D image to generate a first segmentation mask for the first object and a second segmentation mask for the second object. Preferably, the first and/or second segmentation mask is a binary segmentation mask. For example, the pixel value 1 in the segmentation mask indicates the first and/or second object and the pixel value 0 indicates the background or a non-relevant image region in the 2D image. However, different pixel values can also be used for the first and the second object.

In particular, the first and/or second segmentation mask is assigned a label that specifies an object type of the first and/or second object. This means that the instance segmentation model can preferably recognize which object it is.

The instance segmentation model comprises at least one convolutional neural network (CNN) that comprises at least a first module and a second module that are linked to one another. The instance segmentation model can also comprise two or more convolutional neural networks that are the same or different from the at least one convolutional neural network and are preferably linked to one another.

The method furthermore comprises obtaining at least first depth information of the first object from the depth image using the first segmentation mask, and obtaining the dimension of the first object based on the first depth information. Preferably, the first depth information includes the first object segmented in the depth image.

This means that, according to the invention, a distinction is not only made between the background and the object, but also between individual objects, by applying the instance segmentation model. This enables a fast and reliable automatic determination of the dimensions of objects. In particular, it can be effectively prevented that objects that are arranged close next to one another or inside one another are detected as a single object. For example, it is possible to dimension objects in containers directly, and indeed even if the object and the container are approximately the same height. Furthermore, it is possible to individually recognize and/or dimension objects that are close next to one another or contact one another, and indeed here too even if they are a plurality of identical objects or if the objects are approximately the same height.

Advantageous embodiments of the invention are set forth in the dependent claims, in the description and in the drawing.

According to one embodiment, the first object and the second object are arranged next to one another. In particular, the first object and the second object contact one another, for example at a respective side surface. Alternatively, the first object is at least partly arranged, preferably completely arranged, in the second object.

According to one embodiment, the first object and/or the second object comprises/comprise a product (an industrial and/or retail product), a package and/or a container. For example, the first object and the second object are two packages or products arranged next to one another, in particular two packages or products contacting one another. However, the first object can also be a product or package, and the second object can be a container in which the first object is arranged. The container is preferably open on one side facing the camera device.

According to one embodiment, the first object and the second object are the same height, width and/or length. For example, the first object and the second object are identical objects. However, they can also be different objects that have the same length, width and/or height.

According to one embodiment, the first object and the second object are arranged on a device for moving the first and the second object (e.g. a conveyor belt, a conveyor rail and/or a plurality of conveyor rollers rotatably supported next to one another) of the industrial plant, and the 2D image and the depth image are generated when the first object and the second object are arranged between the device for moving the first and the second object and the camera device.

According to one embodiment, the method further comprises obtaining second depth information of the second object from the depth image using the second segmentation mask and obtaining the dimension of the second object based on the second depth information. Preferably, the second depth information includes the second object segmented in the depth image. This procedure ensures a particularly reliable determination of the object dimensions if, for example, they refer to two objects arranged next to one another (in particular if said objects are approximately the same height and/or contact one another). However, if it is, for example, a package or product in a container, it may be sufficient to obtain only the first depth information.

According to one embodiment, the method further comprises extracting a first point cloud of the first object from the depth image based on the first depth information and obtaining the dimension of the first object from the first point cloud.

According to one embodiment, the method further comprises extracting a second point cloud of the second object from the depth image based on the second depth information and obtaining the dimension of the second object from the second point cloud.

The first and/or second point cloud is/are preferably a 3D point cloud.

The obtaining of the dimension of the first object from the first point cloud, and in particular the obtaining of the dimension of the second object from the second point cloud, can take place by applying an adapted dimensioning algorithm to the first point cloud, and in particular to the second point cloud.

According to one embodiment, the application of the instance segmentation model to the 2D image, the obtaining of the first depth information of the first object from the depth image, in particular the obtaining of the second depth information of the second object from the depth image, in particular the extraction of the first point cloud of the first object from the depth image, in particular the extraction of the second point cloud of the second object from the depth image, the obtaining of the dimension of the first object based on the first depth information, in particular the obtaining of the dimension of the first object from the first point cloud, in particular the obtaining of the dimension of the second object based on the second depth information, and/or in particular the obtaining of the dimension of the second object from the second point cloud take place by means of the camera device of the industrial plant.

In other words, the method according to the invention for automatically determining the dimensions of at least one object can be carried out at least partly, preferably completely, by the hardware of the camera device, and indeed within a time period that is suitable for industrial scale applications. For this purpose, the hardware of the camera device and/or the instance segmentation model can be specifically adapted to the respective requirements. For example, the hardware of the camera device can comprise an ASIC (Application Specific Integrated Circuit) or FPGA (Field Programmable Gate Array) configured for the execution of convolutional neural networks. The hardware of the camera can in particular refer to those components which are arranged within the housing of the camera (and do not, for example, first have to be transmitted via a data line that is connected to the housing of the camera and that leads to the outside).

However, at least some or all of the aforementioned method steps can also be carried out by a data processing device that is external with respect to the camera device and that is in communication with the camera device. The external data processing device can be a part of the industrial plant or can be a device that is external with respect to the industrial plant, for example a cloud server.

According to one embodiment, the first module extracts a plurality of feature maps with different degrees of detail from the 2D image, in particular using a number of convolutional filters.

According to one embodiment, the second module combines the plurality of feature maps to generate combined object information.

According to one embodiment, the instance segmentation model, in particular the at least one convolutional neural network, further comprises a third module that is linked to the first module and the second module, wherein the third module generates the first segmentation mask and the second segmentation mask based on the plurality of feature maps and the combined object information.

According to one embodiment, the instance segmentation model comprises an RTMDet model (“Real-Time Model for object Detection”), wherein the first module is the backbone part of the RTMDet model, the second module is the neck part of the RTMDet model, and the third module is the head part of the RTMDet model.

The RTMDet model works particularly reliably and can be adapted to the respective application.

According to one embodiment, the first, second and/or third module comprises/comprise a plurality of layers that are arranged in a hierarchical structure. The layers of the first, second and/or third module can be (in order) an input layer, one or more convolutional layers, one or more activation functions, one or more pooling layers, one or more fully connected layers and/or an output layer.

The input layer can preferably receive input data such as a pixel array, can scale it to a fixed size and can feed it into the convolutional layers. Preferably, the input layer of the first module receives the 2D image, preferably with a resolution of 416×416 pixels or less. This shortens the processing time and saves computing resources.

The convolutional layers preferably use (convolutional) filters (also designated as kernels) to convolve the input data received by the input layer to a certain size and number. The filters can be small trainable weight matrices (e.g. 3×3 or 5×5) that are used to extract features such as edges, textures or other image structures.

With each convolution, the image can be shifted through the filter and a convolution can be performed that results in a feature map. Preferably, the second module, in particular and/or the third module, comprises 48, 96 and/or 192 feature channels, wherein in particular the number of feature channels indicates the number of applied filters. The computing effort can thereby be significantly reduced.

In particular, the neck part includes three different feature maps from the backbone part. The three values 48, 96 and 192 can therefore correspond to the number of channels for these three feature maps. The higher the number of channels, the more detailed the information. This means that the feature map with 48 channels can include rough information about the object, while the feature map with 192 channels can include information about small details about the object. A “feature pyramid” is also spoken of in this respect. The aim of the neck part is to combine the information from these three images such that the object can be recognized and identified as accurately as possible.

After each convolutional layer, an activation function is preferably applied to model the non-linear relationships between the input data and the filtered features. The ReLU function (“Rectified Linear Unit”) is preferably used since it enables a fast calculation. However, a sigmoid-weighted linear unit can also be used.

The convolutional layers are preferably followed by one or more pooling layers that reduce the dimension of the feature maps in order to simplify the calculations and to further improve the spatial invariance. Pooling operations such as max pooling and/or average pooling are preferably applied. Max pooling extracts the maximum within a local range of the input data, while average pooling calculates the mean value of the input data in this range.

The plurality of folding and pooling layers are preferably followed by one or more fully connected layers. In these layers, the high-dimensional features that were extracted by the previous layers are preferably transformed into a flat structure. Each neuron of the fully connected layer is preferably connected to each neuron of the previous layer. These layers serve to combine the extracted features and to make a final prediction or classification.

The output layer preferably delivers the result of the CNN. For example, a softmax activation function is used to generate a probability distribution.

According to one embodiment, the method further comprises training the instance segmentation model with a training data set that comprises a plurality of images, in particular a plurality of RGB images, that were generated by the camera device of the industrial plant and/or by a camera device that is substantially identical in design with respect to the camera device of the industrial plant. The training data set preferably comprises more than five thousand images, preferably with known content. They are therefore “labeled” training data. The training can in particular be “supervised learning”. The model can be specifically adapted to the respective application by the training with the training data set.

The training can be carried out in each step for the entire model (end-to-end). For this purpose, the training data can be used as input for the model to generate segmentation masks therefrom. These generated masks can then be compared with the “ground truth” data. They can be the masks of objects that have been drawn in by hand. The comparison of the current model result with the ground truth can take place via a loss function. The higher the match of the masks, the lower the return value of the loss function. The aim of the training is therefore to parameterize the model such that the loss function becomes as small as possible. All the training data can be used for each training step and all model parameters can be adjusted. The training can be ended as soon as a certain number of iterations is reached or a threshold value for the loss function is fallen below.

Preferably, the training of the instance segmentation model comprises optimizing the first, second and/or third module. This preferably takes place by means of an iterative supervised learning process, in particular using the backpropagation algorithm.

To avoid “overfitting”, regularization techniques such as dropout or L2 regularization are preferably used. Dropout reduces the complexity of the model by randomly deactivating neurons during the training, while L2 regularization restricts the size of the weight matrices to avoid too large weight values.

According to one embodiment, the method further comprises pre-training the instance segmentation model with a freely available data set that comprises a plurality of RGB images. The training data set preferably comprises more than forty thousand RGB images. The pre-training can preferably also comprise supervised learning.

According to one embodiment, the images of the training data set include at least one package and/or at least one product that is at least partly arranged, preferably completely arranged, in at least one container, wherein the package and/or the product and the container preferably have the same height. In particular, the training data set contains labels and/or masks at least for the categories “object” and “container”. In this case, the instance segmentation model can be specifically adapted to determine the dimensions of objects in containers.

According to one embodiment, the images of the training data set include two or more packages and/or two or more products that are arranged next to one another, wherein the packages and/or products arranged next to one another preferably have the same height. The packages and/or products arranged next to one another can contact one another, can partly overlap and/or can be identical. In this case, the instance segmentation model can be specifically adapted to determine the dimensions of objects that are arranged close to one another and/or have the same height.

According to one embodiment, the images of the training data set include two or more packages and/or two or more products that have an at least semi-transparent and/or reflective surface. In this case, the instance segmentation model can be specifically adapted to determine the dimensions of objects whose margins or edges are difficult to detect.

It is understood that the training data set can include all or only some of the aforementioned types of images, depending on the application.

According to one embodiment, the training data set is increased by a data extension process, wherein the data extension process includes applying one or more of the following image processing processes to at least one, some or all of the combination images of the training data set: changing the brightness of the image, adding noise to the image, rotating and/or flipping the image, cutting out a part of an image and adding the part to another image. As a result, more images are available for training the model, whereby the model can be made more robust and less prone to errors.

According to one embodiment, the camera device generates the 2D image and the depth image by recording a combination image, in particular an RGBD image, in particular with a single snapshot, and extracting the 2D image and the depth image from the combination image, in particular the RGBD image. This has the advantage that only one camera device has to be used.

According to one embodiment, the method further comprises controlling at least one part of the industrial plant based on the dimension of the first object, in particular based on the dimension of the first object and the dimension of the second object. For example, based on at least the dimension of the first object, a device for processing the first and/or second object, such as a part of a machine tool of the industrial plant, and/or a device for moving the first and/or second object, such as a conveyor belt, an autonomous transport robot and/or a gripper arm of the industrial plant, is controlled. Since the dimension of at least the first object can be determined particularly quickly and reliably according to the invention, the industrial plant can also be controlled particularly quickly and without errors.

An apparatus for recognizing at least one dimension of at least a first object that is arranged in an industrial plant, in particular in an industrial plant in the logistics sector, is configured and adapted to generate a 2D image and a depth image by means of at least one camera device of the apparatus, wherein the 2D image and the depth image include the first object and at least a second object; to apply an instance segmentation model to the 2D image to generate a first segmentation mask for the first object and a second segmentation mask for the second object; to obtain at least first depth information of the first object from the depth image using the first segmentation mask; and to obtain the dimension of the first object based on the first depth information.

According to one embodiment, the camera device of the apparatus comprises a memory and a processor, wherein the memory includes instructions that, when they are executed by the processor, cause the processor to perform at least some of the steps of the method described above.

The apparatus according to the invention enables a fast and reliable determination of the dimensions of objects, and indeed even if the objects are in contact or are arranged very close to one another, are substantially the same height and/or at least one of the objects is in a container.

The features described in relation to the method according to the invention and their advantages are transferable to the apparatus.

The invention will be described in the following by way of example with reference to the drawing. There are shown:

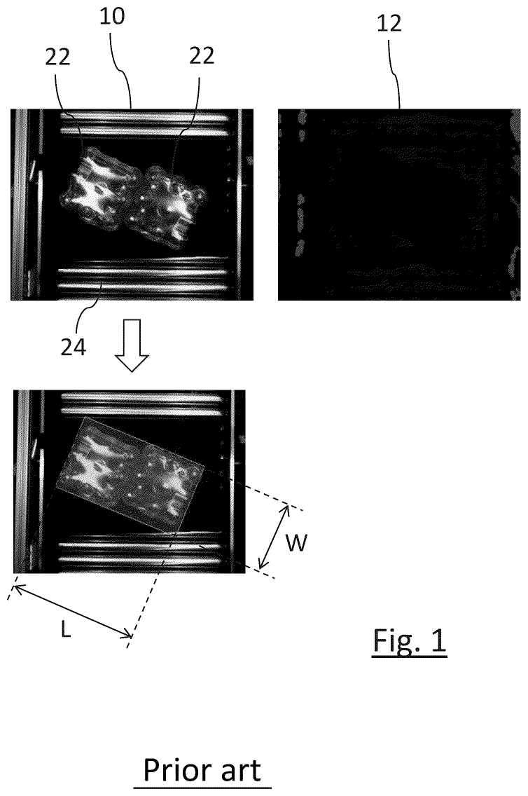

FIG. 1 a schematic representation of a method for determining a dimension of an object according to the prior art;

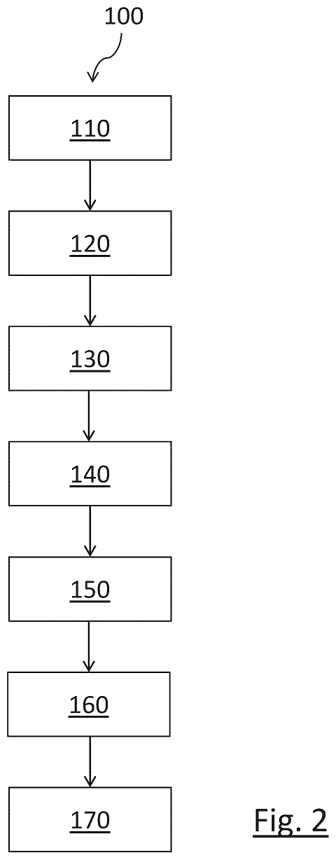

FIG. 2 a flowchart of a method according to the invention for recognizing a dimension of at least one object;

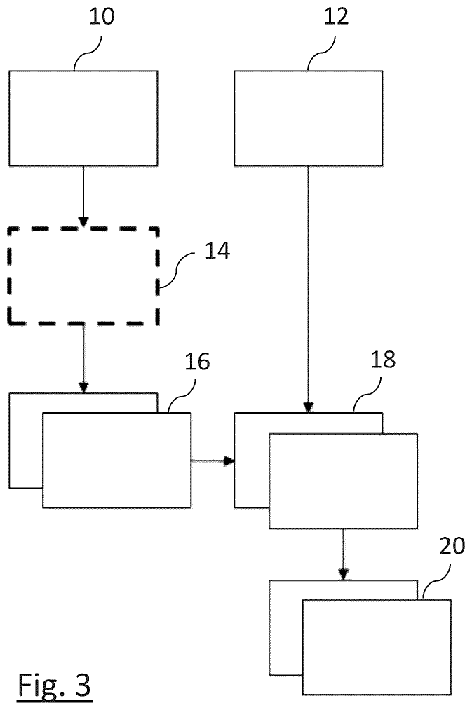

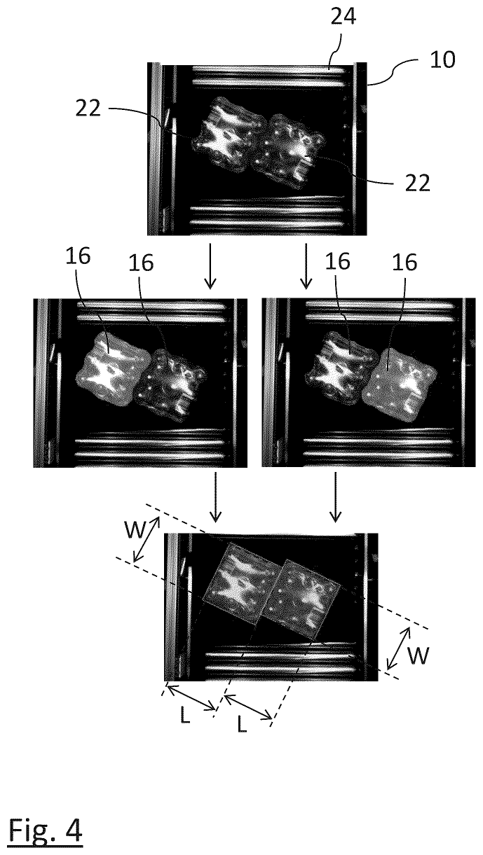

FIGS. 3 and 4 schematic representations of the method in accordance with FIG. 1; and

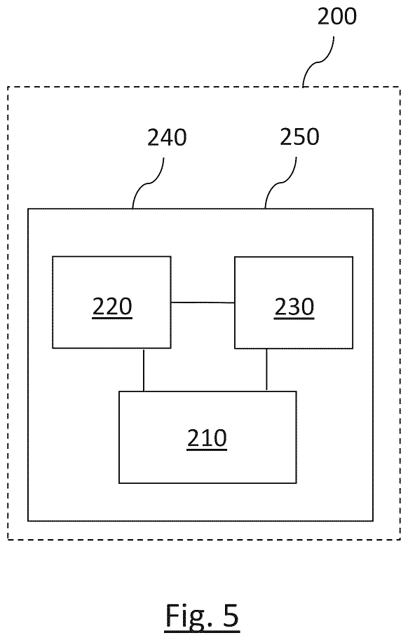

FIG. 5 a highly simplified schematic representation of an apparatus according to the invention for recognizing the dimensions of at least one object.

FIG. 1 shows a schematic representation of a conventional method for determining the dimensions of objects. The method begins with a 2D image 10 and a depth image 12 being generated by one or more image sensors, not shown. In the example shown, the images 10, 12 each include two objects 22 or products on a conveyor belt 24 or conveyor rollers 24.

In the depth image 12, a distinction is then made between the background and the objects 22. This takes place either conventionally or in an AI-based manner, for example by applying a height threshold value. Since the objects 22 are identical and therefore approximately have the same height and are arranged close next to one another, the objects 22 are recognized as a single object and not correctly as two separate objects. This leads to the determination of incorrect dimensions 20, in particular too large a length L and width B.

The same problem, for example, also arises if an object 22 is arranged in an upwardly open container (not shown). In this case, it can occur that the object 22 and the container are detected as one object, in particular if the object 22 and the container have substantially the same height.

According to the invention, these problems are solved in that, instead of the simple distinction between the background and the object 22, an instance segmentation model 14 adapted to the respective application is applied, as will be explained in more detail below with reference to FIGS. 2-4.

Instance segmentation models are among the deep learning models. Due to their complex, multi-layered structure, they are considered to be considerably more computationally intensive than simple machine learning models that usually comprise a CNN with only a single module for performing a specific task (such as distinguishing between the object and the background in a depth image). Surprisingly, it has been found that, despite the limited computing capacities, instance segmentation models can be executed on a camera device of an industrial plant with a clever modification of the input, the backbone module, the neck module and/or the head module, and can indeed in particular be executed sufficiently fast for the respective industrial application.

FIG. 2 shows a method 100 according to the invention for recognizing a dimension 20 of at least one object 22 in which such an instance segmentation model 14 is used. The method 100 begins at step 110 in which the instance segmentation model 14 (see FIG. 3) is trained with a training data set. The training data set includes images, preferably RGB images, that are specifically selected for the respective application.

If, for example, predominantly objects in containers are to be dimensioned automatically, the training data set includes images that at least predominantly include objects in containers. If, on the other hand, objects arranged very close next to one another or objects contacting one another are to be dimensioned automatically, the training data set includes images that at least predominantly include contacting objects or objects positioned close next to one another. It is understood that the training data set can also include a mixture of these images, which makes the model more versatile.

The training data set includes images that were generated by the same camera device or a camera device of identical design on which the trained instance segmentation model 14 is also to be executed. However, they can also be images that were generated by a similar camera device.

The adaptation of the modules of the instance segmentation model 14 takes place by applying a backpropagation algorithm.

To increase the available pool of training data, the training data set is extended by a data extension process.

After training the instance segmentation model 14, a 2D image 10 and a depth image 12 (see FIG. 3) are generated at step 120 by a camera device 240 of an industrial plant (see FIG. 5). The 2D image 10 and the depth image 12 are, for example, extracted from an RGBD image that was recorded by the camera device 240 with only one snapshot. As shown by way of example in the upper part of FIG. 4, the 2D image 10 includes two identical objects 22 arranged close next to one another. However, depending on the application, the images 10, 12 can also include one or more objects 22 in a container (not shown), and/or more than two objects 22 are detected (also not shown).

At step 130, the trained instance segmentation model 14 is applied to the 2D image 10 to generate a separate segmentation mask 16 for each of the objects 22 (see FIG. 3 and the middle part of FIG. 4).

The instance segmentation model 14 is an RTMDet model that comprises a backbone part, a neck part and a head part.

The input for the backbone part, in particular the resolution with which the backbone part receives the 2D image 10, the number of feature channels of the neck part and/or the head part, and/or the activation function of the backbone part, the neck part and/or the head part, are adapted to the respective application as required. For example, the backbone part receives the 2D image 10 with a resolution of 416×416 pixels, the activation function of the backbone part, the neck part and/or the head part is a rectified linear unit, the neck part comprises 48, 96 or 192 feature channels, and/or the head part comprises 48 feature channels. With this architecture of the instance segmentation model 14, the processing time required for the method 100 on the camera device 240 can be significantly reduced. At the same time, a sufficiently precise and reliable dimensioning of objects is possible.

The backbone part extracts a large number of features with increasingly finer details from the 2D image 10. The neck part receives the features of each layer of the backbone, processes them further and combines them. The neck part therefore ensures that the objects 22 are detected correctly. The head part processes the features extracted from the backbone part and the neck part to generate final bounding boxes and the segmentation masks 16.

At step 140, the segmentation masks 16 are used to segment the individual objects 22 in the depth image 12. If it is an object 22 in a container, the mask of the container can be disregarded, i.e. only the object 22 in the container is segmented in the depth image 12. However, if, as shown in FIG. 4, it is a case of two products or packages arranged next to one another, each of the objects 22 is segmented with the corresponding segmentation mask 16 in the depth image 12.

At step 150, a 3D point cloud 18 is extracted for each segmented object 22 (see FIG. 3).

At step 160, the dimensions 20 of each object 22 are determined from the respective point clouds 18. For example, the height, the length L and/or the width B of each object 22 are obtained (see FIG. 3 and FIG. 4 at the bottom). This can take place by an automatic dimensioning algorithm. However, the corner points and/or the angle of rotation of the object can also be obtained.

At step 170, at least a part of the industrial plant is controlled based on the dimensions 20 of the objects 22, the angle of rotation of the objects 22 and/or the corner points of the objects 22. For example, based on the dimensions 20 of the objects 22, a device for processing an object 22, such as a part of a machine tool, is controlled. However, it is also conceivable that a device for moving the objects 22, such as the conveyor belt 24, an autonomous transport robot and/or a gripper arm of the industrial plant, is controlled.

However, the control of at least one part of the industrial plant is not absolutely necessary. For example, the dimensions 20, the angle of rotation and/or the corner points can be stored for storage or palletizing purposes.

FIG. 5 shows a simplified block diagram of an apparatus 200 according to the invention for recognizing the dimension 20 of at least one object 22. The apparatus 200 comprises a camera device 240 that is arranged in an industrial plant. The camera device 240 comprises an optical detection unit 210, a processor 220 and a memory 230 that are arranged in a housing 250 of the camera device 240.

The camera device 240 works according to the stereo vision principle. The optical detection unit 210 therefore comprises two or more separate digital cameras that each have a lens and a photodetector (not shown). However, the optical detection unit 210 can also only have one digital camera.

The processor 220 is configured to execute computer-executable instructions that are stored in the memory 230. The computer-executable instructions comprise at least some, preferably all, of the steps of the method 100 according to the invention.

The camera device 240 furthermore comprises a communication unit (not shown) for the wire-based and/or wireless exchange of data or instructions with an external data processing device. The communication unit e.g. comprises an Ethernet connection and/or a USB connection.

The method 100 according to the invention and the apparatus 200 according to the invention for recognizing at least one dimension 20 of at least one object 22 enable a reliable and fast dimensioning of objects 22 in particularly complicated or problematic applications.

### REFERENCE NUMERAL LIST

10 2D image
12 depth image
14 instance segmentation model
16 segmentation masks
18 point clouds
20 dimensions
22 objects
24 conveyor belt
200 apparatus
210 optical detection unit
220 processor
230 memory
240 camera device
250 housing
L length
B width

1. A computer-implemented method for recognizing at least one dimension of at least a first object that is arranged in an industrial plant, wherein the method comprises:
generating a 2D image and a depth image by means of at least one camera device of the industrial plant, wherein the 2D image and the depth image include the first object and at least a second object;
applying an instance segmentation model to the 2D image to generate a first segmentation mask for the first object and a second segmentation mask for the second object, wherein the instance segmentation model comprises at least one convolutional neural network that comprises at least a first module and a second module that are linked to one another;
obtaining at least first depth information of the first object from the depth image using the first segmentation mask; and
obtaining the dimension of the first object based on the first depth information.

2. The method according to claim 1,
wherein the first object and the second object are arranged next to one another, or
wherein the first object is at least partly arranged in the second object.

3. The method according to claim 1, further comprising,
obtaining second depth information of the second object from the depth image using the second segmentation mask; and
obtaining the dimension of the second object based on the second depth information.

4. The method according to claim 1, further comprising
extracting a first point cloud of the first object from the depth image based on the first depth information; and
obtaining the dimension of the first object from the first point cloud.

5. The method according to claim 1, wherein
the application of the instance segmentation model to the 2D image, the obtaining of the first depth information of the first object from the depth image, and/or
the obtaining of the dimension of the first object based on the first depth information,
take place by means of the camera device of the industrial plant.

6. The method according to claim 1,
wherein the first module extracts a plurality of feature maps with different degrees of detail from the 2D image.

7. The method according to claim 6,
wherein the second module combines the plurality of feature maps to generate combined object information.

8. The method according to claim 7,
wherein the at least one convolutional neural network further comprises a third module that is linked to the first module and the second module, wherein the third module generates the first segmentation mask and the second segmentation mask based on the plurality of feature maps and the combined object information.

9. The method according to claim 1,
wherein the first module and/or the second module, comprises/comprise at least one activation function, wherein the activation function comprises a rectified linear unit, and/or
wherein the second module comprises 48, 96 and/or 192 feature channels.

10. The method according to claim 1,
further comprising training the instance segmentation model with a training data set that comprises a plurality of images that were generated by the camera device of the industrial plant and/or by a camera device that is substantially identical in design with respect to the camera device of the industrial plant.

11. The method according to claim 10,
wherein the images of the training data set include at least one package and/or at least one product that is at least partly arranged in at least one container, and/or
wherein the images of the training data set include two or more packages and/or two or more products that are arranged next to one another.

12. The method according to claim 10,
wherein the training data set is increased by a data extension process, wherein the data extension process includes applying one or more of the following image processing processes to at least one, some or all of the images of the training data set: changing the brightness of the image, adding noise to the image, rotating and/or flipping the image, cutting out a part of an image and adding the part to another image.

13. The method according to claim 1,
wherein the camera device generates the 2D image and the depth image by recording a combination image, and extracting the 2D image and the depth image from the combination image.

14. The method according claim 1, comprising
controlling at least a part of the industrial plant based on the dimension of the first object.

15. An apparatus for recognizing at least one dimension of at least a first object that is arranged in an industrial plant, wherein the apparatus is configured and adapted to carry out the following method steps:
generating a 2D image and a depth image by means of at least one camera device of the apparatus, wherein the 2D image and the depth image include the first object and at least a second object;
applying an instance segmentation model to the 2D image to generate a first segmentation mask for the first object and a second segmentation mask for the second object;
obtaining at least first depth information of the first object from the depth image using the first segmentation mask; and
obtaining the dimension of the first object based on the first depth information.

16. The method according to claim 2,
wherein the first object and/or the second object comprises/comprise a product, a package and/or a container.

17. The method according to claim 4, wherein the method further comprises:
extracting a second point cloud of the second object from the depth image based on the second depth information; and
obtaining the dimension of the second object from the second point cloud.

18. The method according to claim 6,
wherein the first module extracts a plurality of feature maps with different degrees of detail from the 2D image using a plurality of convolutional filters.

19. The method according to claim 10,
wherein the plurality of images are a plurality of RGB images.

20. The method according to claim 13,
wherein the combination image is an RGBD image.

21. The method according to claim 13,
wherein the combination image is taken with a single snapshot.

22. The method according claim 14, wherein the step of controlling at least a part of the industrial plant based is based on the dimension of the first object and the dimension of the second object.
